(19) United States
(12) Patent Application Publication
(10) Pub. No.: US 2006/0218529 A1
(43) Pub. Date: Sep. 28, 2006

(54) Systems and methods for common workspace interface

(75) Inventors: Fernando A. Zayas, Loveland, CO (US); Tomas Blazek, Santa Clara, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Osaka (JP)

(21) Appl. No.: 11/088,552

(22) Filed: Mar. 24, 2005

(51) Int. Cl. G06F 9/44

(52) U.S. Cl. 717/120

(57) ABSTRACT

Using one Common Workspace Interface (CWI) to interact with each script interpreter during communication with the disk drive involves a lot of duplicated work. Embodiments of the present invention allows both the Matlab and Python interpreter to share one common set of code in a single CWI, which represents, stores, and processes variables from both workspaces in one uniform data format. This description is not intended to be a complete description of, or limit the scope of, the invention. Other features, aspects, and objects of the invention can be obtained from a review of the specification, the figures, and the claims.

This application is related to the following publications which are hereby incorporated by reference in their entireties:

U.S. Patent Pub. No. US2004/0193758, ALTERNATIVE IMPLEMENTATION OF VENDOR UNIQUE COMMANDS, Inventors: Fernando Zayas et al., filed Mar. 25, 2003.

### FIELD OF THE INVENTION

The present invention relates to data communication with a disk drive via scripting languages.

### BACKGROUND

A host/application developer can communicate with a disk drive by writing programs in two scripting languages:
Matlab, which is expensive but preferred by servo developers because of its useful features to support signal processing;
Python, which is a public domain type freeware that can be used for most manufacturing and lab scripts.
   Here, the disk drive can be but is not limited to, a magnetic disk, an optical disk, laser-recordable disk, a disk in a single and/or multi-headed disk drive, or any rotating data storage device.

Matlab and Python are interpretive languages that actually work through their respective interpreters that are capable of interpreting instructions and data in the corresponding scripting languages into executable commands, variables, and data structures to perform (data) operation on the underlining disk drive through a Common Work Interface (CWI). The goal of the CWI is to create a bridge between the disk drive and an interpreter so that the developer can access the disk drive using scripting languages. CWI can provide interfaces to hook up to the interpreters, process script instructions and/or data, and communicate downstream to the disk drive via another interface. Building separate CWIs to interface to each of Matlab and Python interpreters however, may be unnecessary and involve tremendous amount of duplicated work, since both CWIs are mostly in common except for the interface part that is tailored for each interpreter.

### BRIEF DESCRIPTION OF THE DRAWINGS

FIG. 1 is a functional diagram showing components of a disk drive that can be used in accordance with embodiments of the present invention.

FIG. 2 is a diagram showing an exemplary data communication architecture using CWI in accordance with embodiments of the present invention.

FIG. 3 shows a flow chart that can be used for data communication between the developer and the disk drive via CWI in accordance with embodiments of the present invention.

FIG. 4 is an exemplary programming model of CWI in accordance with embodiments of the present invention.

### DETAILED DESCRIPTION

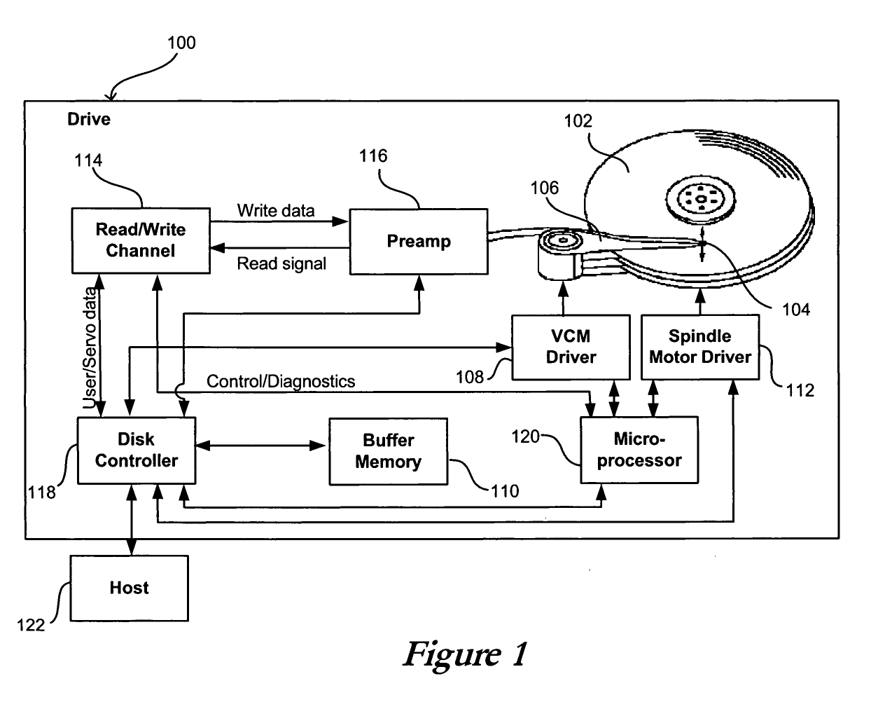

A typical data storage device, such as a disk drive 100 that can be used in systems and methods in accordance with various embodiments of the present invention is shown in FIG. 1. It includes at least one magnetic disk 102 capable of storing information on at least one of the surfaces of the disk. A closed-loop servo system can be used to move an actuator arm 106 and data head 104 over the surface of the disk, such that information can be written to, and read from, the surface of the disk. The closed-loop servo system can contain, for example, a voice coil motor driver 108 to drive current through a voice coil motor (not shown) in order to drive the actuator arm, a spindle motor driver 112 to drive current through a spindle motor (not shown) in order to rotate the disk(s), a microprocessor 120 to control the motors, and a disk controller 118 to transfer information between the microprocessor, buffer memory 110, read channel 114, and a host 122. A host can be any device, apparatus, or system capable of utilizing the data storage device, such as a personal computer or Web server or consumer electronics device. The drive can contain at least one processor, or microprocessor 120, that can process information for the disk controller 118, read/write channel 114, VCM driver 108, or spindle driver 112. The microprocessor can also include a servo controller, which can exist as an algorithm resident in the microprocessor 120. The disk controller 118, which can store information in buffer memory 110 resident in the drive, can also provide user data to a read/write channel 114, which can send data signals to a current amplifier or preamp 116 to be written to the disk(s) 102, and can send servo and/or user data signals back to the disk controller 118. A controller for the data storage device can include the disk controller 118 and/or processor 120. The controller can be on one or multiple chips. In one embodiment, a controller chip contains SRAM while DRAM and FLASH are external to the chip. Other memory arrangements can also be used.

Embodiments of the present invention extend the functionality of different script interpreters by using one (instead of two) CWI (DLL) and a single set of code to access the workspaces of the interpreters. In other words, both Matlab and Python interpreters can share the same CWI (except for the scripting language-specific interfaces) and communicate with the disk drive through one core set of code. Such an approach has resulted in easier implementation and maintenance vs. the traditional approach of having two distinct CWIs, and can save a lot of duplicated work in coding and maintenance since one single set of source code is used by both the Python and Matlab interpreters.

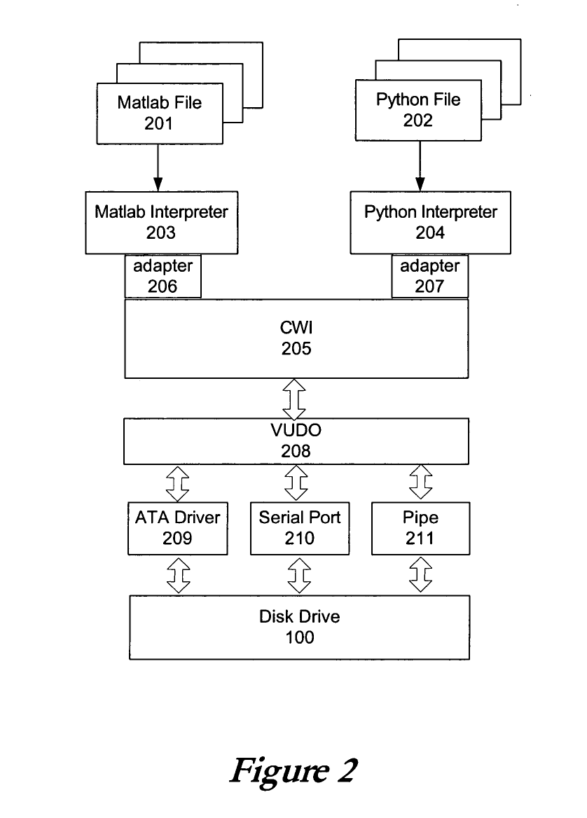

An exemplary CWI supporting both Matlab and Python interpreters is shown in FIG. 2. Each block in the diagram can interact with another adjacent block via an Application Programmable Interface (API). Script files 201 (.m files) and 202 (.py files) written in Matlab and Python scripting languages by an application developer to access the disk drive 100 can be imported to Matlab and Python interpreters (workspaces) 203 and 204, respectively. CWI 205 is actually wrapped in a DLL that supports two APIs on the front end: one 206 interface to the Matlab interpreter and another 207 interface to the Python interpreter during the invocation of that DLL. Technically speaking, these two interfaces 206 and 207 between CWI and Matlab/Python interpreters are language-specific adapters that can be bundled as parts of the CWI, which may accept interpreted script streams (instructions and data) from Matlab and Python interpreters, respectively. On the other side of CWI, CWI can provide a single API to communicate with every layer down to the disk drive so that both interpreters 203 and 204 will be able to see everything down the stream interchangeably, and the code “down the data stream” from CWI does not even need to know which interpreter (or scripting language) it is communicating with. In this way, code that is specific to Matlab or Python can be minimized and does not exist below the CWI block. There are three exemplary disk drive hardware interfaces from the interpreters to the disk drive 100 that can be operated with equal functionality via Vendor Unique Disk Operation (VUDO) layer 208: an ATA driver 209, a serial port 210, and a named pipe (e.g., an ARM simulator) 211. Here, the named pipe is an inter-process communication mechanism that allows one process to communicate with another local or remote process. VUDO 208 is a firmware layer that implements non-publicly available drive unique commands to communicate with the CWI and the disk drive across all of the ATA driver, the serial port, and the ARM simulator pipe. Accordingly, there can be several corresponding modules inside the CWI performing specific functions, which can be but are not limited to, interface related functions, serial port related functions, etc.

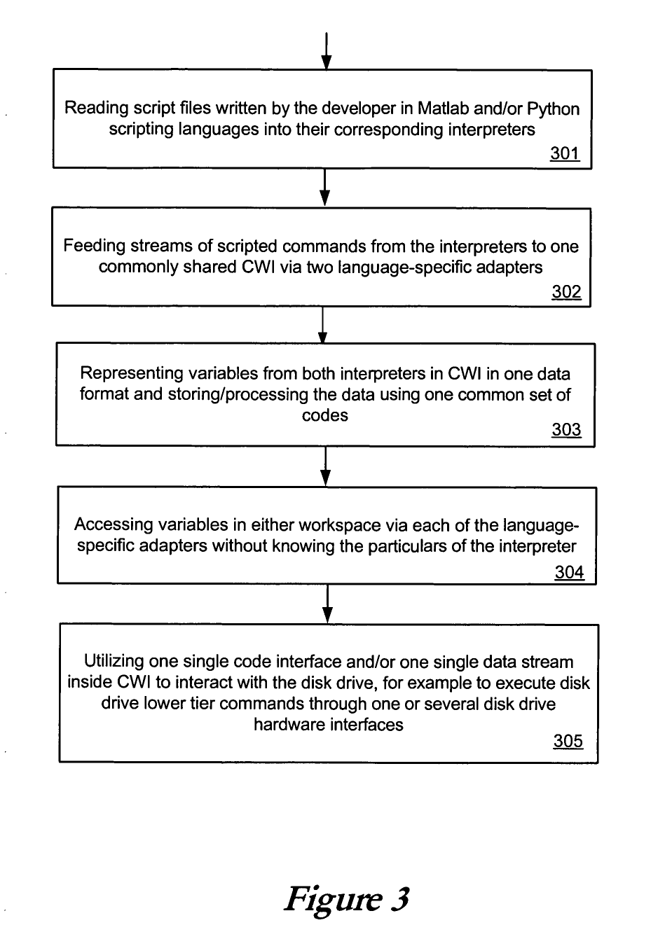

FIG. 3 shows a flow chart that can be used for data communication between the application developer and the disk drive in accordance with the present invention. At step 301, script files written in Matlab and/or Python scripting languages can be read into their corresponding interpreters. These interpreters can then feed streams of scripted commands and data to one commonly shared CWI via two language-specific adapters at step 302, where the CWI is capable of representing data from both interpreters using variables in one unified data format and storing/processing the data using one common set of code at step 303. CWI under a single implementation of DLL can also access variables in either workspace via each of the language-specific adapters without knowing the particulars of the interpreter at step 304. At step 305, CWI may utilize one single interface to interact with the disk drive, for example, to execute disk drive lower tier commands through the one or several disk drive hardware interfaces.

Both Matlab and Python interpreters have a workspace (a software concept where, among other things, the variables of the interpreter reside). An interpreter (workspace) is operable to execute a set of instructions, which may access a set of variables or internal data structures. The way to access data in a Matlab variable is different from the way a Python variable is accessed. Because there are a lot of commonalities between the two ways of accessing the variables, the CWI treats the location of the variables in the two workspaces in the same way as if they were interchangeable instead of duplicating that difference all the way from the interpreter to the disk drive. It carries internally the interpretation of the data, which is received from (and sent to the disk drive), or moved back (from the disk drive) to Matlab or Python interpreter only through the language adapters 206 and 207. The rest (most) of the activities (operations) over the data that needs to be done are restricted to one common block of code inside CWI for both interpreters.

In some embodiments, CWI is able to access the variables in one format and only convert them to Python or to Matlab variables at the last moment if necessary. Both Matlab and Python have their own methods that can be used to touch their own workspace, and there are different representations of variable types, data types and storage mechanisms throughout. The way variables are represented in Python and in Matlab is quite different: in Python, variables in a format commonly used by the application scripts are treated as characters of one byte or integers of four bytes, while in Matlab, they are represented as double precision floating point numbers using 8 bytes. CWI can decide which of the formats to use, and the format of the variables chosen in CWI is more Python-like than Matlab-like since a variable in the integer format of Python is slimmer in its interpretation or implementation than Matlab. Thus, a single byte data element although represented by 8 bytes of data in Matlab double precision floating point representation will go down the data stream to the disk drive as one byte; similarly in Python, the same single byte data element represented as one character string or 4 byte integer will remain as one byte or 4 bytes, respectively, and goes as such down the data stream to the disk drive. CWI will stick to the tighter representation of variables when the data is communicated down to the disk drive and up to the interpreter, and will only convert this tight internal data representation into double precision format in Matlab via language adopter 206 and/or into string variables in Python via language adopter 207 when interacting with the corresponding Matlab and/or Python interpreters, respectively. Notice that CWI does not know anything about Matlab or Python code, object, or script. Its main function is to bridge the DLL to the data areas (workspace) of the two languages by making the data formats of the variables consistent.

In some embodiments, CWI can be implemented using common C++ code to interface with the workspaces of both Python and Matlab. As previously discussed, it allows one set of C++ code to be written that interfaces with the workspace (the variables) of both Python and Matlab. By using an interface class, CWI can create DLL extensions for both Python and Matlab to add the same functionality to each interpreter.

In some embodiments, the DLL contains two coexisting base entry points, i.e. the two language adapters 206 and 207 contain separate functions, accessible from each interpreter/environment, which provides the gateway for the script calls to CWI internals. This way, only one integrated CWI is needed when only a tiny part is individualized for Matlab and Python.

In some embodiments, the language adapters for the scripting languages split into a part specific to that scripting language and the common part handling drive, data, protocols etc. internally in CWI. The language specific part essentially consists of:
Parsing of the input arguments;
Wrapping of the return values into an internal representation as needed by the respective scripting language; and
Hooking-up error reporting and output functions into Matlab and Python.

In some embodiments, the VUDO commands can perform functions on the disk drive that include but are not limited to, Physical seek, R/W channel register access, etc. In execution of those commands, methods such as: peek, poke, call (P/P/C) are used to read from disk drive's memory address space, write to it, and call subroutines in it, respectively. The detail implementation of P/P/C protocol varies per different interfaces (ATA, serial port, ARM simulator) but P/P/C implements a general remote procedure call (RPC) mechanism from the host to the drive.

In some embodiments, the CWI can be implemented as an abstract class (to define the interface) and two derivations, one for Python and the other for Matlab. It adopts the same programming model of extensions for Matlab and Python. Matlab's extension model is a DLL with a single entry point which serves as a gateway into the various functions implemented by the DLL. The gateway typically handles input parameter checking and dispatches to the function called for by the arguments. A non-limiting example in Matlab may look like:
X=MatlabExtension (openFunc, . . . );
MatlabExtension (closeFunc, X);

Python's extension model is a DLL that becomes a new Python module. While there is still only a single entry point, this is a data structure that defines the methods of the module. As such, the extension appears to have multiple entry points. A non-limiting example in Python may look like:
X=PythonExtension.open( . . . );
PythonExtension.close(X);

In order to have a single set of source files for the same functionality in both languages, the CWI may define a single method in the Python extension named “gateway” that will be used like the Matlab extension so that the same parameters can be specified in both cases. For a non-limiting example, suppose an extension named vudo is to be added to both interpreters. The script in Matlab would look like:
(a,b,c, . . . )=vudo( operation, m, n, o, . . . );
In Python, it may look like:
(a,b,c, . . . )=vudo.gateway(operation, m, n, o, . . . );
In this manner, the common source code in CWI sees a common user interface from both languages.

In some embodiments, the operation field in the two examples above can specify which function of the DLL to perform. The CWI may intend to maintain the definitions of these operation codes to be consistent across three languages: C++ (the implementation language of the DLLs), Matlab, and Python. To this end, a very simple include file for C++ named (in this non-limiting example) vudooperations.h and a simple tool to translate these definitions into the corresponding .M (Matlab) and .PY (Python) files can be defined. Entries in this include file to be translated are exactly of the form:
const uint32 vudoOpSvoSeek=107;
const uint32 vudoOpIoSeek=108;
Entries of this form can be converted into Matlab and Python entries as follows:
vudoOpSvoSeek=107;
vudoOpIoSeek=108;
This conversion tool will strip off all other non-comment lines (e.g., the #ifndef) from the include file to produce two files with the same content as show above (both Python and Matlab understand this assignment syntax).

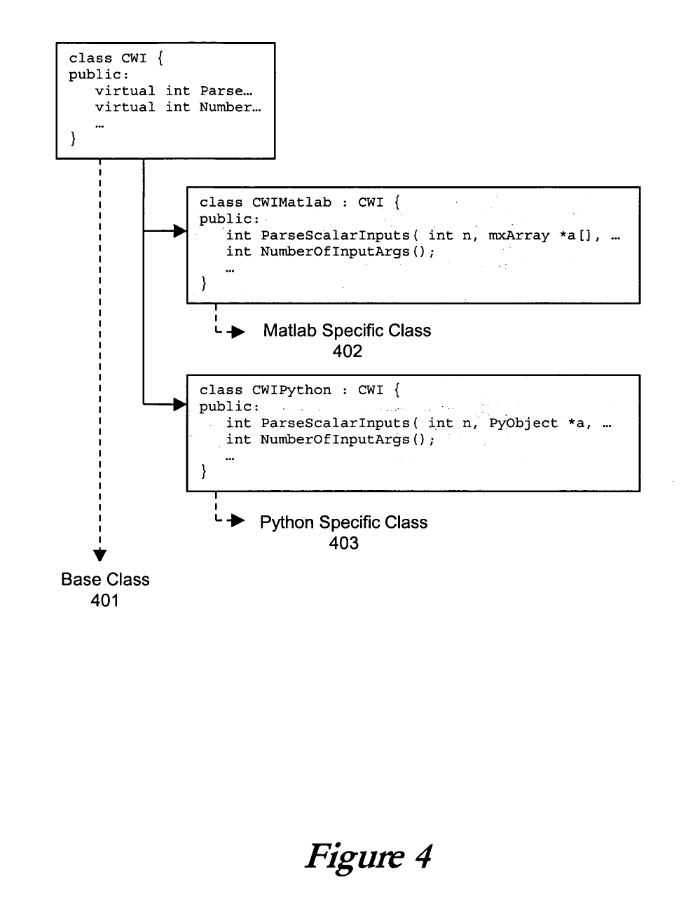

In some embodiments, the CWI can be implemented as a two tier class hierarchy as shown in FIG. 4. The base class 401, an interface class, defines the interface and two classes are derived from this: A Matlab specific class 402 and a Python specific class 403. The common source code relies on the interface class definition to do its work. And the gateway function instantiates the correct class for the interpreter it is invoked for.

The following example illustrates how the CWI can extend the functionalities of Matlab and Python interpreters via a DLL and carries variables that are originally in integers (Python) or double precisions (Matlab) format through to disk drive or the interpreters. When the interpreters communicate with the disk drive, such reading a sector and getting the data back to the interpreters, one of the key commands is the “seek” operation.

An exemplary Matlab script for seek operation, ServoSeek.m, is shown below. It performs a seek operation to cylinder ‘intCyl’, head ‘head’, of type ‘seekType, and an offset ‘round( . . . )’. “call()” is a helper function that hides the CWI P/P/C details.

intCyl = floor(cyl);
leftOver = (cyl−intCyl)*2\hat{ }12;
err = call(‘SelfTestHostDiskAccess::Seek( )’, intCyl, head, seekType,
round(offset+leftOver));
seekWedgeCount = call(‘SelfTestHostDiskAccess::GetSeekTime( )’,
lookup(‘selfTestHostDiskAccess’);
if (err)
fprintf([‘Error: 0x’ dec2hex(err) ‘.’]);
end

An exemplary Python script for seek operation, Seek.py, having the same effect but without the wrapping “call()” function (so that the use of lower level Peek/Poke/Call (PPC) opcode is exposed) is shown below. Notice that the same routine is being called with the parameters in the same order, and both calls returning an error as the function value.

```
physicalCylinder = translationResult[
  PhysicalTranslation.PhysicalTranslation.CYL ]
physicalHead =
translationResult[ PhysicalTranslation.PhysicalTranslation.HD ]
err = PPC.Call( conduit, ‘SelfTestHostDiskAccess::Seek( )’,
  physicalCylinder, physicalHead, seekType, offset )
return err
```

These two scripts illustrate how much commonality is shared by the scripts in either language as indicated by the underlined instructions, both are supported with the very same, single CWI.

In some embodiments, the wrapping of CWI calls (or use of helper functions, as presented in examples above) can be done slightly differently for Matlab and Python workspaces due to different features and user preferences of those two scripting languages (Matlab vs. Python). The unwrapped version (implementation of the same seek script using a “raw” call to CWI) of the seek operation however shows, that it is even possible to use the same script line that calls the physical seek in each environment. In another non-limiting example of accessing the disk drive by cylinder, the Matlab script may look like:

% using global cwiHandlePublic!
intCyl = floor( cyl );
leftover = (cyl−intCyl)*(2\hat{ }12);
offset = round( offset+leftover );
[errCode, result] = cwi( ‘call’, cwiHandlePublic,
‘SelfTestHostDiskAccess::Seek( )’, intCyl, head, seekType, offset );
if (0<errCode)
fprintf( “Error: 0x%02X\n”, errCode);
end

While the Matlab script may look like:

# using global cwiHandlePublic!
intCyl = int( cyl );
leftover = (cyl−intCyl)*pow(2, 12);
offset = round( offset+leftover );
[errCode, result] = cwi( ‘call’, cwiHandlePublic,
‘SelfTestHostDiskAccess::Seek( )’, intCyl, head, seekType, offset );
if (0<errCode):
print( “Error: 0x%02X\n” % errCode);

The other similarities between the Matlab and Python are due to the virtues of the respective scripting languages and such commonality helps fast porting of working scripts from one environment to the other. It should also be clear to anyone skilled in the art that extending this concept to additional scripting languages, such as Ruby, is possible and straight forward.

Although embodiments described herein refer generally to systems having a read/write head that can be used to write bursts on rotating medium (magnetic media), similar advantages can be obtained with other such data storage systems or devices. For example, a laser writing information to an optical media can take advantage of additional passes when writing position information. Any media, or at least any rotating media in a single and/or multi-headed disk drive, upon which information is written, placed, or stored, may be able to take advantage of embodiments of the present invention.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

What is claimed is:

1. A method for data communication with a disk drive via scripting languages, comprising:
accepting and interpreting one or more script files written in a first scripting language via a first script interpreter and maintaining data in one or more variables in a workspace of the first script interpreter;
accepting and interpreting one or more script files written in a second scripting language into a second script interpreter and maintaining data in one or more variables in a workspace of the second script interpreter;
representing, processing, and storing the one or more variables in workspaces of both the first and the second script interpreter using one common set of codes and in one uniform data format via a common workspace interface (CWI); and
utilizing one single interface to interact with the disk drive through one or more lower tier commands downstream.

2. The method according to claim 1, wherein:
the first and second scripting language can be one of Matlab, Python, and Ruby.

3. The method according to claim 1, further comprising:
implementing the CWI in a two-tier class hierarchy, which includes a base class and two derived script language-specific subclasses for the first and second script interpreter, respectively.

4. The method according to claim 1, further comprising:
interfacing with the first and the second script interpreter via a first and a second language adapter to convert the one or more variables from the one uniform data format in CWI to the data format in the first and the second script interpreters, respectively.

5. The method according to claim 1, further comprising:
accessing the one or more variables in workspaces of the first and/or the second script interpreter via the first and/or language-specific adapters respectively without knowing the details of the first and/or the second interpreter.

6. The method according to claim 1, further comprising:
utilizing a Vendor Unique Disk Operation (VUDO) layer to interact with the CWI via the single interface; and
performing peek, poke, or call operations on the disk drive via an ATA driver, a serial port, and a named pipe.

7. A system for data communication with a disk drive via scripting languages, comprising:
a first script interpreter operable to accept and interpret one or more script files written in a second scripting language and maintain data in one or more variables in its workspace;
a second script interpreter operable to accept and interpret one or more script files written in a second scripting language and maintain data in one or more variables in its workspace; and
a common workspace interface (CWI) operable to:
represent, process, and store the one or more variables in the workspaces of both the first and the second script interpreter using one common set of codes and in one uniform data format; and
utilize a single interface to interact with the disk drive through one or more lower tier commands downstream.

8. The system according to claim 7, wherein:
the disk drive can be a magnetic disk, an optical disk, laser-recordable disk, a disk in a single and/or multi-headed disk drive, or a rotating data storage device.

9. The system according to claim 7, wherein:
the first and second scripting language can be one of Matlab, Python, and Ruby.

10. The system according to claim 7, wherein:
the CWI can be implemented in C++.

11. The system according to claim 7, wherein:
the CWI can be implemented in a two-tier class hierarchy, which include a base class and two derived script language-specific subclasses for the first and second script interpreter, respectively.

12. The system according to claim 7, wherein:
the CWI further comprises a first and a second language adapter operable to interface with the first and the second script interpreter to convert the one or more variables from the one uniform data format in CWI to the data format in the first and the second script interpreter, respectively.

13. The system according to claim 7, wherein:
the CWI is further operable to access the one or more variables in workspaces of the first and/or the second script interpreter via the first and/or language-specific adapters respectively without knowing the details of the first and/or the second interpreter.

14. The system according to claim 7, further comprising:
a Vendor Unique Disk Operation (VUDO) layer operable to:
interact with the CWI via the single interface; and
perform peek, poke, or call operations on the disk drive via an ATA driver, a serial port, and a named pipe.

15. A system for data communication with a disk drive via scripting languages, comprising:
means for accepting and interpreting one or more script files written in a first scripting language via a first script interpreter and maintaining data in one or more variables in a workspace of the first script interpreter;
means for accepting and interpreting one or more script files written in a second scripting language into a second script interpreter and maintaining data in one or more variables in a workspace of the second script interpreter;
means for representing, processing, and storing the one or more variables in workspaces of both the first and the second script interpreter using one common set of codes and in one uniform data format via a common workspace interface (CWI); and
means for utilizing one single interface to interact with the disk drive through one or more lower tier commands downstream.
